(19) United States
(12) Patent Application Publication
(10) Pub. No.: US 2025/0205771 A1
(43) Pub. Date: Jun. 26, 2025

(54) CAMSHAFT

(71) Applicant: MAHLE International GmbH, Stuttgart (DE)

(72) Inventors: Justus Himstedt, Stuttgart (DE); Matthias Rimmele, Stuttgart (DE); Stefan Steichele, Gerlingen (DE)

(21) Appl. No.: 18/988,861

(22) Filed: Dec. 19, 2024

(30) Foreign Application Priority Data
Dec. 20, 2023 (DE) 10 2023 135 918.5

(51) Int. Cl. B21D 53/84; F01L 1/047

(52) U.S. Cl. CPC B21D 53/845; F01L 1/047; F01L 2303/00

(57) ABSTRACT

A method for manufacturing cams for a camshaft is disclosed. The method includes finish-forging the cam with at least one chamfer. The chamfer is not reworked after finish-forging. According to an example. the cam is finish-forged with the chamfer with an angle of 5°≤α≤40° to a cam bearing surface.

### CROSS-REFERENCE TO RELATED APPLICATIONS

This application claims priority to German Patent Application No. 10 2023 135 918.5 filed on Dec. 20, 2023, the contents of which are hereby incorporated by reference in its entirety.

### TECHNICAL FIELD

The present invention relates to a method for manufacturing cams for a camshaft. The invention also relates to a cam produced by this method.

### BACKGROUND

A method for manufacturing a cam for a camshaft is known from EP 1 707 763 A1, in which a cam blank with a pre-forged cam chamfer is produced in several individual method steps using the cold forging process. This cam chamfer, like a bearing surface, is reworked by a subsequent turning and/or milling process. With forged cam chamfers, it is generally not possible to prevent the formation of burrs in the area of the side surface/bearing surface on the cam chamfer due to the chamfered facets, which are usually produced at an angle between 30° and 60°, wherein the resulting burr causes an increased risk of injury and must therefore be reworked.

Reworking cam chamfers involves a considerable amount of additional work, which significantly increases the unit costs for such cams.

The present invention therefore deals with the problem of specifying a method by which cams with chamfers can be produced significantly more cost-effectively, but still accurately.

According to the invention, this problem is solved by the object of the independent claim(s). Advantageous embodiments are the object of the dependent claims.

### SUMMARY

The present invention is based on the general idea of no longer just pre-forging a cam with a chamfer located between a bearing surface and a side surface, as has been the case up to now, and then reworking it by means of a complex and cost-intensive milling or turning operation, but rather, for the first time, finish-forging it and not reworking the chamfer. The cam chamfers are thus forged and finish-forged in terms of their angle and width during the forging process. All dimensions are based on the technically sensible and feasible forging tolerance, for example, a component width, a chamfer width, a chamfer depth, a chamfer angle, or radii. The finish-forging of the cams with the chamfers and the elimination of the subsequent reworking of the chamfers means that the cam itself can be produced much faster and at a lower cost.

In a favorable further development of the method according to the invention, the cam is finish-forged with a chamfer at an angle of α between 5° and 40° to a cam bearing surface. Generally, the chamfer angle to a camα bearing surface between 10° and 80°, preferably between 8° and 37°, can be finish-forged. In a particularly preferred embodiment of the method according to the invention, the cam is finish-forged with a chamfer with an angle α of 10°≤α≤30° to a cam bearing surface. The angle ranges mentioned cover all the angles that usually occur between the chamfer and the cam bearing surface, so that all cams can be produced using the method according to the invention.

In a particularly preferred embodiment of the method according to the invention, the chamfer is finish-forged with an area with a radius of R≤2.0 mm. Consequently, the chamfer itself does not have to have a linear surface in cross-section, but can also represent an arc. In theory, it is even possible to have chamfers that have both a straight and a curved area in cross-section. With the method according to the invention, in which the chamfer is finish-forged regardless of its shape and is not reworked, almost any chamfer can be produced depending on the forging tool used.

In a particularly preferred embodiment of the method according to the invention, the side surfaces of the cam are ground. Grinding the side surfaces, which can alternatively be replaced by turning, can create a flat side surface and at the same time even out any unevenness caused by forging. It is conceivable that the two side surfaces are machined in parallel, i.e., simultaneously, wherein the side surface machining offers the major advantage that pre-machining of the cam bore can be dispensed with. The elimination of the pre-machining of the cam bore means that the cam can be produced more cost-effectively.

In a favorable further development of the method according to the invention, the cam is cold forged. This offers the major advantage that the forging of the cam can be carried out with significantly less energy and thus at significantly lower cost compared to a hot forging.

In a particularly preferred further development of the method according to the invention, the cam is finish-forged with a chamfer in a single forging step. This makes it possible to significantly streamline the forging process and thus shorten cycle times.

The present invention is based on the general idea of manufacturing a cam according to the method described in the previous paragraphs. This allows the advantages described with regard to the method to be transferred to the cam according to the invention. Specifically, these advantages lie in the fact that the cam, which is finish-forged with the chamfers, can be used without further reworking of the chamfers. In particular, no turning or milling of the chamfers is required, which means that the cam according to the invention can be produced in a less complex and therefore significantly more cost-effective manner.

Further important features and advantages of the invention are apparent from the sub-claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTON OF THE DRAWINGS

They show, each schematically,

FIG. 1 a view of a cam with finish-forged chamfers, manufactured using a method according to the invention,

FIG. 2 a detailed view A from FIG. 1 with a linear chamfer surface,

FIG. 3 a representation as in FIG. 2, but with a chamfer surface bent in cross-section.

### DETAILED DESCRIPTION

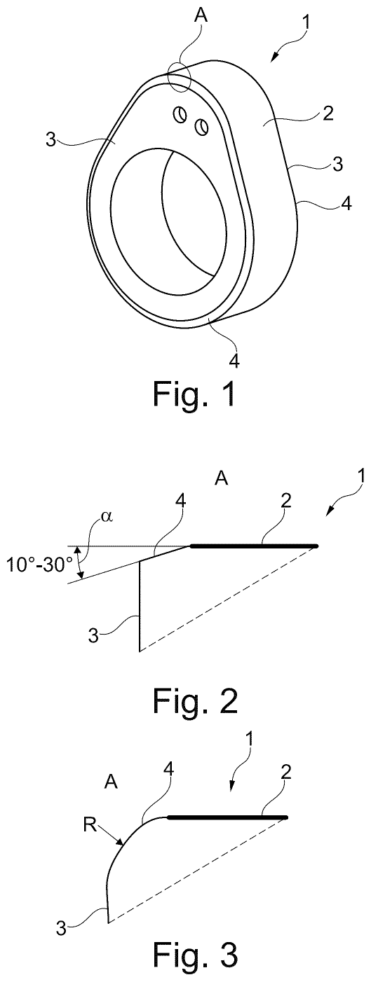

According to FIGS. 1-3, a cam 1 according to the invention has a cam bearing surface 2, two side surfaces 3, and two chamfers 4. The cam 1 according to the invention is used, for example, on a camshaft of an internal combustion engine, in particular in a motor vehicle.

According to the invention, the cam 1 is now finish-forged, preferably in a single step, together with at least one chamfer 4, preferably with both chamfers 4, so that, in comparison to cams known from the prior art, the chamfers 4 no longer need to be reworked. In theory, it is also conceivable that cam 1 could be finish-forged, preferably in a single step, together with just one chamfer 4, so that, compared to cams known from the prior art to date, this chamfer 4 would no longer need to be reworked.

This not only makes it possible to produce cam 1 faster and with less effort, but also significantly more cost-effectively.

If you look at FIG. 2, cam 1 can be finish-forged with a chamfer 4 with an angle α of 5°≤α≤40°, preferably with an angle of 8°≤α≤37°, and very particularly preferably with an angle α of 10°≤α≤30° to the cam bearing surface 2. The smaller the angle, α the lower the tendency for burr formation when grinding the bearing surface (the chamfer remains unmachined). At α 10° to 30°, subsequent deburring can be dispensed with.

The chamfer 4 may also have an area with a radius R≤2 mm and be finish-forged with such a radius R (see FIG. 3). It is also conceivable that a chamfer will be finish-forged in chamfer 4, which has an area with a linear chamfer surface in cross-section (see FIG. 2) and a curved chamfer surface in cross-section (see FIG. 3). This results in a hybrid of chamfers 4 from FIGS. 2 and 3.

The side surfaces 3 can still be reworked, in particular turned, milled, or ground, so that an overall width of the cam 1 can also be adjustable. The side surfaces 3 can be ground, for example, by discus grinding, in which the plane-parallel cams 1 are ground using the side surfaces 3 of the grinding tool. The decisive factor in this process is the combination of the forged chamfer and the discus grinding. Cost reduction is achieved by grinding at least two cams simultaneously. This was not possible before with milling or turning.

In the method according to the invention, cam 1 is usually cold forged, which enables a longer service life for the forging tools.

With the method according to the invention and the finish-forged cam lobes 1 manufactured according to this method according to the invention, i.e., cam lobes 1 with at least one finish-forged chamfer 4, the manufacture of such cam lobes 1 can be carried out with significantly less effort and thus at significantly lower cost.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A method for manufacturing cams for a camshaft, comprising:
finish-forging a cam with a chamfer,
wherein the chamfer is not reworked.

2. The method according to claim 1, wherein the cam is finish-forged with the chamfer with an angle of 5°≤α≤40° to a cam bearing surface.

3. The method according to claim 1, wherein the cam is finish-forged with the chamfer at an angle of 8°≤α≤37° to a cam bearing surface.

4. The method according to claim 1, wherein the cam is finish-forged with the chamfer with an angle of 10°≤α≤30° to a cam bearing surface.

5. The method according to claim 1, wherein the chamfer is finish-forged at least in an area with a radius of R≤2.0 mm.

6. The method according to claim 1, further comprising grinding side surfaces of the cam.

7. The method according to claim 1, wherein the cam is cold forged.

8. The method according to claim 1, wherein the cam is finish-forged with the chamfer in a single forging step.

9. A cam manufactured using the method according to claim 1.

10. The method according to claim 2, wherein the chamfer is finish-forged at least in an area with a radius of R≤2.0 mm.

11. The method according to claim 2, further comprising grinding side surfaces of the cam. -

12. The method according to claim 2, wherein the cam is cold forged.

13. The method according to claim 2, wherein the cam is finish-forged with the chamfer in a single forging step.

14. The method according to claim 5, further comprising grinding side surfaces of the cam.

15. The method according to claim 5, wherein the cam is cold forged.

16. The method according to claim 5, wherein the cam is finish-forged with the chamfer in a single forging step.

17. A cam for a camshaft, comprising:
a finished-forged chamfer that is not reworked.

18. The cam of claim 17, wherein the cam is cold-forged.

19. The cam of claim 17, wherein the chamfer has an angle of 5°≤α≤40° to a cam bearing surface.

20. The cam of claim 17, wherein the chamfer has a radius of R≤2.0 mm at least in an area.
